(19) United States
(12) Patent Application Publication
(10) Pub. No.: US 2021/0215567 A1
(43) Pub. Date: Jul. 15, 2021

(54) WATER LEAK DETECTION SYSTEM INTEGRATED WITH INDOOR MAP

(71) Applicants: Ronald Koo, Los Altos, CA (US); Hoang Doan Vo, Anaheim, CA (US); Dennis Chang, Seal Beach, CA (US)

(72) Inventors: Ronald Koo, Los Altos, CA (US); Hoang Doan Vo, Anaheim, CA (US); Dennis Chang, Seal Beach, CA (US)

(21) Appl. No.: 17/144,544

(22) Filed: Jan. 8, 2021

Related U.S. Application Data
(60) Provisional application No. 62/960,576, filed on Jan. 13, 2020.

(51) Int. Cl. G01M 3/18; E04D 13/00; G01M 3/40

(52) U.S. Cl. CPC G01M 3/18; G01M 3/40; E04D 13/006

(57) ABSTRACT

A method is provided for water leak detection that uses radio waves in which an antenna transmits a repeated pattern of radio waves that reflect from wet areas, antennas receive the reflected radio waves, signal analysis is done on the received radio waves to determine the location of the wet areas on an indoor map. Other systems and embodiments of the invention are described and shown.

### CROSS REFERENCE TO RELATED CASES

This case claims priority to U.S. Provisional Patent Application Ser. No. 62/960,576, entitled “WATER LEAK DETECTION SYSTEM INTEGRATED WITH INDOOR MAP,” by Ronald Koo et al., filed Jan. 13, 2020, the disclosure of which is incorporated by reference herein in its entirety.

### BACKGROUND

### Technical Field

The present invention relates to methods for detecting water leaks and water leak detection systems, typically used in new and retrofitted buildings.

### Background Art

The following is a listing of art that presently appears possibly relevant, but not necessarily material to the patentability of the claims listed below:

| Patent Number | Kind Code | Issue Date | Patentee |
|---|---|---|---|
| 9,753,131 | B2 | 2018 Sep. 5 | Adib et al. |
| 9,857,805 | B2 | 2018 Jun. 2 | Halimi |
| 10,428,495 | B2 | 2019 Oct. 1 | Halimi |
| 8,319,508 | B2 | 2012 Nov. 27 | Vokey |
| 9,244,030 | B2 | 2016 Jan. 26 | Vokey et al. |
| 10,345,188 | B2 | 2019 Jul. 9 | Vokey et al. |

F. Adib, Z Kabelac, D. Katabi, and R. C. Miller, “3D Tracking via Body Radio Reflections,” Usenix NSDI'14, Seattle, Wash., April 2014. [Online]. Available: http://witrack.csail.mit.edu/witrack-paper.pdf. [Accessed Jun. 30, 2019].
F. Adib, Z Kabelac, D. Katabi, and R. C. Miller, “WiTrack: Motion Tracking via Radio Reflections off the Body,” Usenix NSDI'14, Seattle, Wash., April 2014. [Online]. Available: http://people.csail.mit.edu/fadel/slides/WiTrack-slides.pptx. [Accessed Jun. 30, 2019].
F. Adib, Z. Kabelac, and D. Katabi, “Multi-Person Localization via RF Body Reflections,” Usenix NSDI'15, Oakland, Calif., May 2015. [Online]. Available: http://witrack.csail.mit.edu/witrack2-paper.pdf. [Accessed Jun. 30, 2019].
F. Adib, Z. Kabelac, and D. Katabi, “Multi-User Localization from Human Reflections,” Usenix NSDI'15, Oakland, Calif., May 2015. [Online]. Available: http://people.csail.mit.edu/fadel/slides/WiTrack2-slides.pptx. [Accessed Jun. 30, 2019].
C. Eichhorn, “Electric Field Vector Mapping,” IIBEC Interface magazine, June 2002.
D. Vokey, “A Method to Detect and Locate Roof Leaks Using Conductive Tapes,” BEST2 Conference, WB8 Moisture Measurement, Apr. 12-14, 2010.

Water-damage claims are the biggest payout for the insurance industry, accounting for $13 billion dollars of water-damage bills for homeowners' insurance companies in 2017. The main causes of the problem are old pipes and an increasing number of connections to the plumbing system in newer homes.

Homes that were built from the 1940s to the 1970s commonly had galvanized pipe, which has a typical lifetime of forty years. From the 1970s onwards, the building industry switched from galvanized pipe to copper pipe. The lifetime of copper pipe is fifty to seventy years. It can be as short as twenty years if the water is acidic or alkaline. The result is that buildings have plumbing systems that are past their lifetimes.

In newer homes, fire sprinkler systems, wet bars, water-filtration systems, extra bathrooms, and appliances that need a water supply create more points of connection into the plumbing system, providing more opportunities for leaks. Homeowners also want their laundry room on an upstairs floor whereas older homes had their laundry machines in the garage. A leak from an upstairs laundry room can cause more damage to the house than a leak from a laundry machine sitting on the concrete floor of the garage.

Other contributing factors are that homeowners like high water pressure so that water flows quickly and comes out in high volumes. High water pressure causes plumbing fixtures to wear out quickly. The plumbing fixtures themselves might have lifetimes of as low as two to three years because their quality has decreased with the advent of big box stores that emphasize low price as their primary advantage.

Besides plumbing leaks, a building can also have roof leaks. The lifetime of a roof is between twenty to forty years, depending upon the roofing material and the quality of the installation. Near the end of its life, the roof can develop holes and cracks that allow water to penetrate it into the building.

Insurance companies require property owners to install in-line water sensors on the water main of a building after a major water claim caused by a plumbing leak. The device described in U.S. Pat. No. 9,857,805 to Halimi is an example of the in-line water sensor. The in-line water sensors have problems in that they cannot differentiate leaks from the normal operation of low-flow appliances, detect slow leaks, localize leaks, or find leaks from water sources other than the main water supply of the building. Their cost is high because plumbers install them.

Halimi in U.S. Pat. No. 10,428,495 to Halimi describes a device that is cheaper than an in-line water sensor because a plumber does not need to install it. Any person can attach the device to a hose bib, shower outlet, sink outlet, or some other water outlet in the building in order to detect a falling water pressure, indicating a leak in the building's plumbing system. The conditions of the leak test are that all water outlets are closed and that the water main shutoff valve is also closed. Therefore, the leak in the system would be the reason for the water pressure to decrease. The drawbacks to this measurement system are that it cannot do continuous monitoring of the building and cannot localize the leak.

The water sensors attached to the plumbing system cannot detect roof leaks, which are caused by external water sources such as rain. Thermal imaging of either the roof itself or the ceiling under the roof is a commonly used technique to detect leaks because wet areas are oftentimes cooler than dry areas. In practice, thermal imaging is a spot measurement and not used for continuous monitoring of the building.

Electric field vector measurement, which is described in the article “Electric Field Vector Mapping” by Eichhorn, is a method of pinpointing the leak in a roof membrane by following the voltage gradient on a wet roof to a penetration. This method is limited to insulating roof membranes and mostly performed on flat roofs. Just like with thermal imaging, electric field vector measurement is a discrete event and not used for continuous monitoring.

U.S. Pat. No. 10,345,188 to Vokey et al. describes a method that comprises a use of a device with two electrical sensing probes and a common electrical connection to detect leaks in a relatively horizontal, electrically conductive membrane roof. The device is moved over the roof in order to locate the leak. Again, this method is performed once in a discrete manner and not used for continuous monitoring.

Vokey in U.S. Pat. No. 8,319,508 to Vokey and U.S. Pat. No. 9,244,030 to Vokey et al. describe methods to monitor roofs continuously for leaks and to locate them. Conductors in the roof and equipment in the building are installed for leak monitoring. Specifically retrofitting the roof to monitor for leaks will be expensive unless the roof needed to be replaced anyhow.

Radio wave sensors have been developed to monitor building interiors continuously. See, e.g., U.S. Pat. No. 9,753,131 to Adib et al., as well as publications entitled: (1) “3D Tracking via Body Radio Reflections,” (2) “WiTrack: Motion Tracking via Radio Reflections off the Body,” (3) “Multi-Person Localization via RF Body Reflections,” and (4) “Multi-User Localization from Human Reflections,” a publication that describes a system to track the movement of people in a building by the reflections of radio waves from their bodies. The goal of his research project is to monitor seniors who might fall and not be able to get up. In an extension of this research, Adib et al. use radio wave sensors to measure the gait, heart rate, and breathing rates of the people who are being tracked. The focus of the research project is human health rather than building health. The system is not user friendly and not deployable at scale because it is not integrated with an indoor building map.

Thus, opportunities exist to provide improvements to methods and systems for detecting water leaks, e.g., in new and/or retrofitted buildings, as well as units of such buildings.

### SUMMARY

In general, a method is provided for water leak detection that uses radio waves in which an antenna transmits a repeated pattern of radio waves that reflect from wet areas. The method performs signal analysis on received radio waves to determine location(s) of wet area(s). As a result, wet areas are displayed on an indoor map.

In a first embodiment, a method is provided for water leak detection. The method typically involves emitting a transmitted signal comprising repetitions of a transmitted signal pattern from a transmitting antenna. At each receiving antenna of a set of receiving antennas, a signal is received comprising reflections of the transmitted signal. Each received signal is processed to form successive patterns of reflections of the transmitting signal pattern from an increasing wet area. The successive patterns of reflections are processed so as to include retaining effects of direct reflections from the increasing wet area and so as to exclude at least some effects of multipath reflections from the increasing wet area that are also reflected from at least one static object. A location of the increasing wet area is determined on an indoor map using a result of processing the successive patterns of reflections and the locations of the transmitting antennas and the receiving antennas. The increasing wet area indicates a water leak, and a person can find said water leak because the increasing wet area is located on said indoor map.

The location of the increasing wet area may be referenced to the locations of the transmitting antenna and the receiving antennas. In addition or in the alternative, the location of the increasing wet area is referenced to absolute coordinates.

In some instances, water from a leaking appliance creates the increasing wet area. Water from a leaking pipe and/or plumbing fixtures may also create the increasing wet area. External water may further penetrate a building to create the increasing wet area. Further still, water from a fire sprinkler may create the increasing wet area. Typically, the increasing wet area is coincident with a ceiling, wall, or floor.

The inventive method may include further steps as well. For example, an alarm may be sounded and/or an alert may be sent when the increasing wet area is detected. The water supply to a portion of a building or to an entire building may be shut off when said increasing wet area is detected. Optionally, the inventive method may involve localizing a moving body.

In another embodiment, a water leak detection system is provided. The system comprises: a transmitting antenna and a set of receiving antennas; a transmitter coupled to the transmitting antenna and configured to generate a transmitting signal comprising repetitions of a transmitting signal pattern; a receiver coupled to the set of receiving antennas, for receiving signals comprising reflections of the transmitting signal; and a processor coupled to the transmitter and to the receiver. The processor is configured to cause the system to emit a transmitted signal comprising repetitions of a transmitted signal pattern from a transmitting antenna, to receive, at each receiving antenna of a set of receiving antennas, a received signal. The signal comprises reflections of the transmitted signal. Each received signal may be processed to form successive patterns of reflections of the transmitting signal pattern from increasing wet areas. In addition, the system may process successive patterns of reflections including retaining effects of direct reflections from the increasing wet area and excluding at least some effects of multipath reflections from the increasing wet area that are also reflected from at least one static object. As a result, a location of the wet area on an indoor map may be determined using a result of processing the successive patterns of reflections and the locations of the transmitting antenna and the receiving antennas, whereby the increasing wet area indicates a water leak. As a result, a person can find the water leak because the wet area is located on the indoor map.

Variants of the water leak detection system are possible. For example, the location of the increasing wet area may be referenced to the locations of the transmitting antenna and the receiving antennas and/or to absolute coordinates. The increasing wet area may be created from a leaking appliance, from a leaking pipe and plumbing fixtures, from external water penetrating a building, and/or from water from a fire sprinkler.

In any case, the increasing wet area may be coincident with a ceiling, wall, and/or floor.

The invention provides several advantages previously unknown in the art. For example, the invention allows for continuous monitoring for building water leaks caused by an internal plumbing system or external water sources. The invention also facilitates installation of water sensors without a plumber in new or existing buildings. The invention further allows a practitioner of the art to localize water leaks with reference to an indoor map, to display water leaks on an indoor map, and to alert building operators of water leaks. Other advantages of one or more aspects will be apparent from a consideration of the drawings and ensuing description.

### BRIEF DESCRIPTION OF THE DRAWINGS

In the drawings, closely related figures have the same number but different alphabetic suffixes.

FIG. 1 is a diagram of a physical layout of a room with a wet area caused by a leak in a fire sprinkler system and a schematic block diagram of a water leak detection system with an indoor map.

FIG. 2A is a plot of transmitting and receiving frequencies over time, FIG. 2B is a plot of received energy over frequency corresponding to FIG. 2A, and FIG. 2C is a plot of received energy over frequency as the wet area in FIG. 1 increases in area.

FIG. 3 is a diagram of intersecting spheroids calculated by the water leak detection system corresponding to FIG. 1.

FIG. 4 is a diagram of the indoor map with a water leak symbol in the area of the water leak corresponding to FIG. 1.

FIG. 5 is a diagram of a physical layout of a room with one wet area caused by a leak in a fire sprinkler system and a schematic block diagram of a water leak detection system with concurrent transmissions from multiple transmitting antennas.

FIG. 6A is a plot of transmitting frequencies from two transmitting antennas over time and receiving frequencies over time. FIG. 6B is a plot of received energy over frequency corresponding to FIG. 6A.

### DETAILED DESCRIPTION

Before describing various embodiments of the present invention in detail, it is to be understood that the invention is not limited to specific water detection systems. It is also to be understood that the terminology used herein is for the purpose of describing particular embodiments only and is not intended to be limiting.

In addition, as used in this specification and the appended claims, the singular article forms “a,” “an,” and “the” include both singular and plural referents unless the context clearly dictates otherwise. Thus, for example, reference to “an antenna” includes a single antenna as well as a plurality of antennas, reference to “a system” refers to a single system as well as a plurality of systems, and the like.

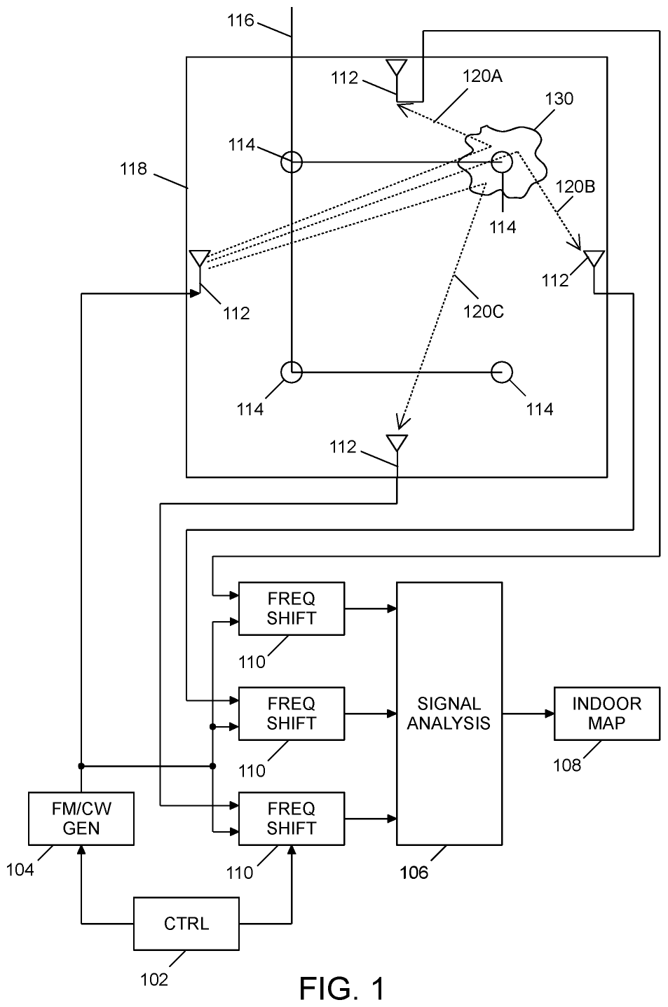

An exemplary system is shown in FIGS. 1-4 with a single transmitting antenna and multiple receiving antennas.

FIG. 1 shows an embodiment of the water leak detection system with a single transmitting antenna and multiple receiving antennas. The water leak detection system is installed in a building to monitor water intrusion from a hole in the roof and/or walls, a leak in a pipe and/or plumbing fixtures, a malfunctioning water appliance, and so forth. Room 118 has fire sprinkler pipe 116 and a number of fire sprinkler heads 114 installed in the ceiling. Water leak 130 is caused by a small hole in a seal between the fire sprinkler pipe 116 and a 90-degree elbow fire sprinkler pipe fitting near fire sprinkler head 114. Such leaks are more common in areas with pipe joints. The flow of water from the small hole is low such that the insulating material in the ceiling absorbs water for several years before the water reaches drywall.

A number of antennas 112 are located on or in the walls of room 118. The related paths 120A, 120B, and 120C, show the travel of radio waves between various pairs of antennas 112. Signal generator 104 creates a waveform for transmitting antenna 112 and a reference for a number of frequency shift components 110. Signal analysis module 106 determines the location of water leak 130. Controller 102 operates the water leak detection system. Indoor map 108 indicates the position of water leak 130 on a map of the building.

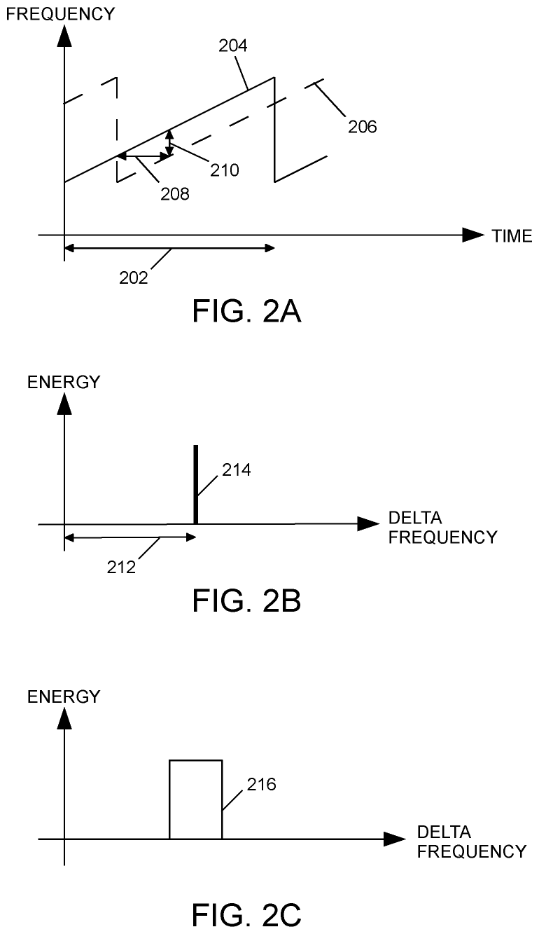

In FIG. 2A, solid line 204 represents a transmitting signal of a single transmitting and receiving antenna pair, and dashed line 206 represents a receiving signal of the pair. The transmitting signal repeats on time intervals 202 of duration T. The receiving signal is delayed by time-of-flight (TOF) 208 as the radio wave created by transmitting antenna 112 travels to a single wet area, reflects from the wet area, and then travels to the receiving antenna 112. Difference 210 in transmitting and receiving signals is a product of the TOF and a rate of frequency change of a swept carrier for the transmitting antenna.

Energy 214 in FIG. 2B is an energy of a downshifted signal out of frequency shift component 110. Frequency difference 212 corresponds to the TOF. Energy band 216 in FIG. 2C results when water leak 130 increases in size.

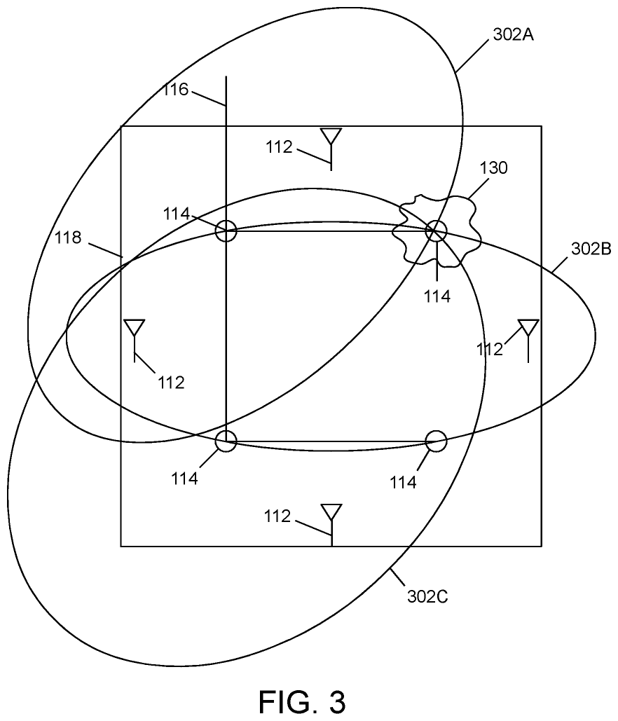

In FIG. 3, ellipse 302A is a two-dimensional representation of a spheroid formed by the related path 120A. The transmitting antenna 112 is a focus of the spheroid, and the receiving antenna 112 is the other focus of the spheroid. Ellipse 302B is a two-dimensional representation of a spheroid formed by the related path 120B. Ellipse 302C is a two-dimensional representation of a spheroid formed by the related path 120C.

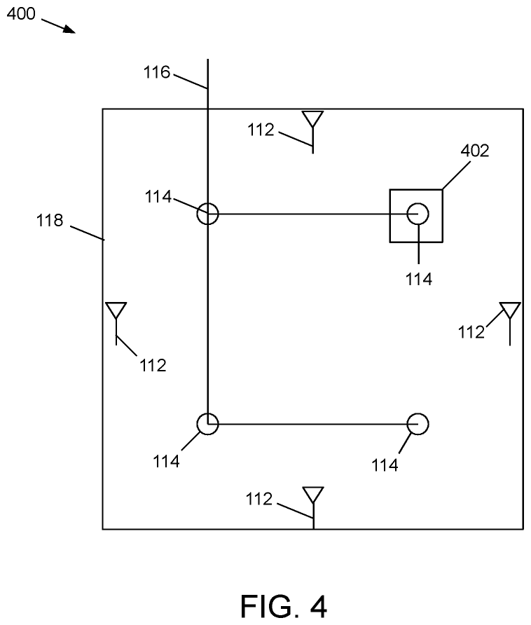

Icon 402 in FIG. 4 shows a location of water leak 130 on indoor map 400.

In operation, the embodiment of the water leak detection system shown in FIGS. 1-4 locates water leaks by the times-of-flight of repeated, continuous, frequency modulated radio waves from the single transmitting antenna 112, to the water leak, and then from the water leak to three receiving antennas 112. The times-of-flight indicate the distances that the radio waves have travelled. For each single transmitting and receiving antenna pair, the water leak lies on a spheroid in which the two foci are the transmitting antenna and the receiving antenna and where the sum of the distances from the two foci to any point on the spheroid is the distance that the radio wave has travelled.

Three transmitting and receiving antenna pairs with their respective spheroids localize the water leak in three-dimensional space. The water leak lies at the intersection of the three spheroids.

The location of the water leak is incorporated into the indoor map 108 of the building. Human users can access the indoor map 108 locally and remotely for a display of the water leak 130 on the indoor map 108. Information systems can access the indoor map 108 for monitoring purposes and send alerts based upon the water leaks 130 that are detected.

The controller 102 resets, initializes, and monitors signal generator 104 and signal analysis module 106. The controller 102 sends locations of the transmitting antenna 112 and the receiving antennas 112 to signal analysis module 106. In another embodiment, the controller 102 dynamically finds their locations in three-dimensional space and then sends locations to signal analysis module 106. Locations of the transmitting antenna 112 and the receiving antennas 112 are referenced to an absolute coordinate system or relative to each other. Signal generator 104 outputs a repeating frequency modulated carrier wave, shown by solid line 204. Transmitting antenna 112 broadcasts the radio wave corresponding to the frequency modulated carrier wave into the room 118. The radio wave reflects from conducting liquids such as water leak 130 because water will contain mobile ions such as sodium that are present in the environment. The water leak 130 will create multiple reflections shown by related travel paths 120A, 120B, and 120C. The radio waves have a finite propagation speed and take time to travel from transmitting antenna 112 to the water leak and to receiving antennas 112, which convert the reflected radio waves into signals that are sent to frequency shift components 110. Dashed line 206 shows the reflected radio wave from a single transmitting and receiving antenna pair.

The frequency shift components 110 multiply the signals from the receiving antenna 112 and signal generator 104 together and passes a result through a low pass filter so that the energy 214 at the frequency difference 212 between signals remains and higher frequencies are greatly attenuated.

As water leak 130 increases in area, more radio waves reflect from the expanding areas of water leak 130 to receiving antennas 112. The times-of-flight of the radio waves vary because they reflect from different physical locations of water leak 130. The result is that the energy 214 expands into energy band 216 as the varying times-of-flight become varying frequency differences.

Signal analysis 106 calculates the times-of-flight of the radio waves from the energies at frequency differences and then derives distances that the radio waves have travelled from the times-of-flight. In an air-filled environment, the radio waves travel at approximately the speed of light. Signal analysis 106 calculates three-dimensional spheroids (their two-dimensional representations are ellipses 302A, 302B, and 302C) in which foci are the locations of the transmitting antenna 112 and the receiving antennas 112 and major axes are distances that respective radio waves have travelled. Intersections of the spheroids are the locations of the water leak 130.

Signal analysis 106 forwards coordinates of the water leak to indoor map 108 for the convenience of users who want to find the water leak 130. Indoor maps are a dominant reference system for indoor spaces because they can be generated from architectural plans of the building. The user can look at the indoor map with the water leak 130 highlighted as icon 402 and then go to the corresponding location in the real building and repair the water leak 130.

The radio wave that is broadcast from the transmitting antenna 112 most likely has shorter, direct paths to the receiving antennas 112 compared to the paths 120A, 120B, and 120C reflected from the water leak 130. The radio waves on the shorter, direct paths have shortest transit times, arrive before the radio waves that reflect from water leak 130, and have greater signal strength. The signals generated at the receiving antennas from the radio waves on the shorter, direct paths are ignored because they do not provide useful information about water leak 130. The times-of-flight calculated from those signals result in degenerate spheroids that are straight lines between the transmitting antenna and the receiving antenna.

Room 118 likely contains conductive surfaces that are not water. Signal analysis 106 interprets all conductive surfaces as potential water leaks because radio waves reflect from conductive surfaces. Real water leaks increase their area over time. Signal analysis 106 records locations of potential water leaks over time and classifies those potential water leaks that grow their area over time as likely water leaks.

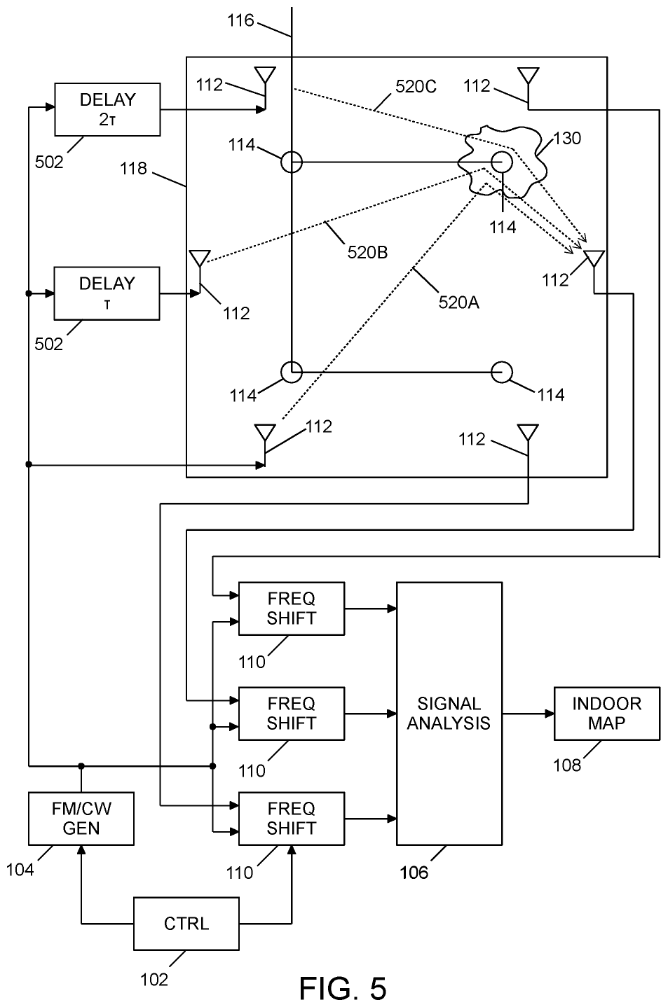

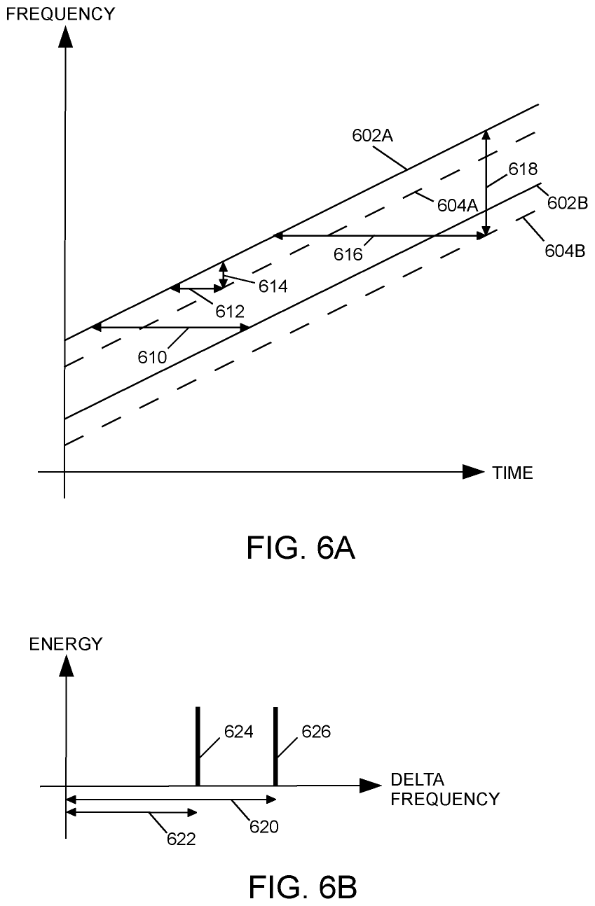

FIGS. 5 and 6 show a system with multiple transmitting antennas and multiple receiving antennas.

FIG. 5 shows an embodiment of a water leak detection system with multiple transmitting antennas 112 and multiple receiving antennas 112. Related paths 520A, 520B, and 520C show travel of reflected radio waves between various pairs of antennas 112. Delay element 502 delays a waveform created by signal generator 104 by multiples of a time τ.

In FIG. 6A, solid line 602A represents a signal of a first transmitting antenna 112. Solid line 602B represents the same signal delayed by time 610, a single τ, of a second transmitting antenna 112. A radio wave on path 520A creates a signal at receiving antenna 112 shown by dashed line 604A. A radio wave on path 520B creates a signal at the receiving antenna 112 shown by dashed line 604B.

The receiving signal shown by dashed line 604A is delayed by the time-of-flight (TOF) 612 as the radio wave created by first transmitting antenna 112 travels on path 502A to a single wet area, reflects from the wet area, and then travels to the receiving antenna 112. The difference 614 in transmitting and receiving signals is a product of the TOF and a rate of frequency change of a swept carrier for the first transmitting antenna 112.

The receiving signal shown by dashed line 604B is delayed by time 616, which is the combination of time τ and time-of-flight of the radio wave on path 502B. The difference 618 in transmitting and receiving signals is a product of time 616 and a rate of frequency change of a swept carrier for the second transmitting antenna 112.

Energy 624 in FIG. 6B is energy of a downshifted signal out of frequency shift component 110 when the transmitting signal represented by solid line 602A is multiplied by the receiving signal represented by dashed line 604A. The frequency difference 622 corresponds to the TOF.

Energy 626 in FIG. 6B is energy of a downshifted signal out of frequency shift component 110 when the transmitting signal represented by solid line 602A is multiplied by the receiving signal represented by dashed line 604B. The frequency difference 620 corresponds to time 616.

The operation of system with multiple transmitting antennas and multiple receiving antennas is described below:

Multiple transmitting antennas and multiple receiving antennas increase the number of possible transmitting-receiving pairs. With N transmitting antennas and M receiving antennas, a maximum number of transmitting-receiving pairs is N×M. Each transmitting-receiving pair detects wet areas in a room. The more transmitting-receiving pairs covering a room, the better the results because more data is gathered and analyzed.

In the embodiment shown in FIG. 5, the transmitting antennas 112 concurrently send signals. The first transmitting antenna 112 sends the waveform generated by signal generator 104. The second transmitting antennas 112 sends the waveform delayed by τ. The third transmitting antenna 112 sends the waveform delayed by time 2τ. The time τ is longer in duration than the times-of-flight of any reflected radio waves in room 118.

Multiple reflected waves will reach each receiving antenna 112 because signals are being sent out from multiple transmitting antennas. The receiving signal shown by dashed line 604A and the receiving signal shown by dashed line 604B sum together at the receiving antenna 112. After the frequency shift component 110 downshifts a sum of those signals, a resulting signal has the energy 624 at frequency difference 622 and the energy 626 at frequency difference 620.

Signal analysis 106 interprets energy 624 and energy 626 as reflected radio waves indicative of water leak 130. The time-of-flight calculation for energy 624 is the same as energy 214. The time-of-flight calculation for energy 626 corrects for the radio wave being delayed by time τ at the second transmitting antenna 112. Signal analysis 106 calculates distances that radio waves have travelled from times-of-flight and then creates three-dimensional spheroids.

Multiple transmitting antennas increase the transmitting-receiving antenna pairs that probe an environment for water leaks 130. More spheroids should be calculated for the embodiment with multiple transmitting antennas than the embodiment with a single transmitting antenna. As a result, more spheroids will intersect. Signal analysis 106 has more data to improve confidence that water leak 130 exists or locate more water leaks 130 in room 118.

### DRAWINGS—REFERENCE NUMERALS

102 Controller
104 Signal generator
106 Signal analysis module
108 Indoor map
110 Frequency shift component
112 Antenna
114 Fire sprinkler head
116 Fire sprinkler pipe
118 Room
120A, 120B, 120C Paths
130 Water leak
202 Time interval
204 Solid line (transmitting antenna signal)
206 Dashed line (receiving antenna signal)
208 TOF
210 Difference
212 Frequency difference
214 Energy
216 Energy band
302A, 302B, 302C Ellipses
400 Indoor map
402 Icon
502 Delay element
520A, 520B, 520C Paths
602A, 602B Solid line (signals)
604A, 604B Dashed line (signals)
610 Time
612 Time-of-flight
614 Difference
616 Time
618 Difference
620 Frequency difference
622 Frequency difference
624 Energy
626 Energy

Thus, a number of conclusions, ramifications, and scoping issues are apparent from the above disclosure. For example, the inventive water leak detection system integrated with indoor map can detect water leaks caused by multiple types of water sources and locate them on an indoor map. In addition, the water leak detection system senses wet areas that are hidden from view such as those wet areas that are in a wall, in a ceiling, or in a floor.

Furthermore, the electronic nature of the water leak detection system and the indoor map has these additional novel and nonobvious advantages:

It detects small leaks that would take weeks, months, or years to grow to an appreciable size.

If the water leak detection system is connected to the internet, then alerts or alarms can be sent to people or other systems.

If the water leak detection system with integrated indoor map is connected to the internet, then remote people can view the water leak on an indoor map.

It senses humans, animals, and moving robots in the same indoor environment.

It can send the location of the water leak to an indoor map program in a smartphone, tablet, or augmented reality headset so that people can navigate to the water leak.

It can send the location of the water leak to an indoor map program in a robot, which can navigate to the water leak.

It can be part of a building information management system.

Although the description above contains many specificities, these should not be construed as limiting the scope of the embodiments but as merely providing illustrations of some of several embodiments. For example, the antennas of the water leak detection system within one room can sense a water leak in an adjacent room. With respect to the embodiment of the water leak detection system with multiple transmitting antennas and multiple receiving antennas, many other variations are possible:

One transmitting antenna at a time broadcasts a signal.

The antennas dynamically change their operation between transmitting and receiving.

The transmitting antennas each have a uniquely modulated signal so that the transmitting antennas can broadcast concurrently and still have the receiving antennas identify the source of the signal.

The transmitting antennas broadcast radio waves encoded with time stamps, the receiving antennas get the reflected radio waves, signal analysis 106 decodes the time stamps and compares them against the times at which they were received to calculate the times-of-flight of the radio waves.

Thus, the scope of the embodiments should be determined by the appended claims and their legal equivalents, rather than by the examples given.

All patents and publications cited herein are hereby incorporated by reference to an extent not inconsistent to the above disclosure.

What is claimed is:

1. A method for water leak detection, the method comprising:
emitting a transmitted signal comprising repetitions of a transmitted signal pattern from a transmitting antenna;
receiving, at each receiving antenna of a set of receiving antennas, a received signal comprising reflections of the transmitted signal;
for each received signal,
processing the received signal to form successive patterns of reflections of the transmitting signal pattern from an increasing wet area, and
processing the successive patterns of reflections including retaining effects of direct reflections from said increasing wet area and excluding at least some effects of multipath reflections from said increasing wet area that are also reflected from at least one static object; and
determining a location of said increasing wet area on an indoor map using a result of processing the successive patterns of reflections and the locations of the transmitting antennas and the receiving antennas,
whereby said increasing wet area indicates a water leak.

2. The method of claim 1, wherein said location of the increasing wet area is referenced to the locations of the transmitting antenna and the receiving antennas.

3. The method of claim 1, wherein said location of the increasing wet area is referenced to absolute coordinates.

4. The method of claim 1, wherein water from a leaking appliance creates said increasing wet area.

5. The method of claim 1, wherein water from a leaking pipe and/or plumbing fixtures create said increasing wet area.

6. The method of claim 1, wherein external water penetrates a building to create said increasing wet area.

7. The method of claim 1, wherein water from a fire sprinkler creates said increasing wet area.

8. The method of claim 1, wherein said increasing wet area is coincident with a ceiling, wall, or floor.

9. The method of claim 1, further comprising sounding an alarm when said increasing wet area is detected.

10. The method of claim 1, further comprising sending an alert when said increasing wet area is detected.

11. The method of claim 1, further comprising shutting off the water supply to a portion of a building or to an entire building when said increasing wet area is detected.

12. The method of claim 1, further comprising localizing a moving body.

13. A water leak detection system, comprising:
a transmitting antenna and a set of receiving antennas;
a transmitter coupled to the transmitting antenna and configured to generate a transmitting signal comprising repetitions of a transmitting signal pattern;
a receiver coupled to the set of receiving antennas, for receiving signals comprising reflections of the transmitting signal;
a processor coupled to the transmitter and to the receiver, configured to cause the system to
emit a transmitted signal comprising repetitions of a transmitted signal pattern from a transmitting antenna;
receive, at each receiving antenna of a set of receiving antennas, a received signal comprising reflections of the transmitted signal;
for each received signal,
process the received signal to form successive patterns of reflections of the transmitting signal pattern from increasing wet area, and
process the successive patterns of reflections including retaining effects of direct reflections from said increasing wet area and excluding at least some effects of multipath reflections from said increasing wet area that are also reflected from at least one static object; and
determine a location of the wet area on an indoor map using a result of processing the successive patterns of reflections and the locations of the transmitting antenna and the receiving antennas,
whereby said increasing wet area indicates a water leak locatable on said indoor map.

14. The water leak detection system of claim 13, wherein said location of the increasing wet area is referenced to the locations of the transmitting antenna and the receiving antennas.

15. The water leak detection system of claim 13, wherein said location of the increasing wet area is referenced to absolute coordinates.

16. The water leak detection system of claim 13, wherein water from a leaking appliance creates said increasing wet area.

17. The water leak detection system of claim 13, wherein water from a leaking pipe and/or plumbing fixtures creates said increasing wet area.

18. The water leak detection system of claim 13, wherein external water penetrates a building to create said increasing wet area.

19. The water leak detection system of claim 13, wherein water from a fire sprinkler creates said increasing wet area.

20. The water leak detection system of claim 13, wherein said increasing wet area is coincident with a ceiling, wall, or floor.
